(19) United States
(12) Patent Application Publication
(10) Pub. No.: US 2009/0187771 A1
(43) Pub. Date: Jul. 23, 2009

(54) Secure data storage with key update to prevent replay attacks

(76) Inventor: Hubert Rae McLellan, JR., Union County, NJ (US)

Correspondence Address: RYAN, MASON & LEWIS, LLP, 90 FOREST AVENUE, LOCUST VALLEY, NY, 11560, US

(21) Appl. No.: 12/015,770

(22) Filed: Jan. 17, 2008

(51) Int. Cl. H04L 9/06

(52) U.S. Cl. 713/193

(57) ABSTRACT

A key update process applied to encrypted memory in a processing system determines an address from contents of a boundary register, reads an encrypted data block from a memory location specified by the address, decrypts the encrypted data block using a first key, re-encrypts the decrypted data block using a second key, writes the re-encrypted data block back to the memory location specified by the address, and updates the boundary register. These operations are repeated for one or more additional addresses. The boundary register contents are also used to determine appropriate keys for use in other read and write transactions to the memory. The key update process can be run as a background process, separate from the other read and write transactions to the memory, so as to incur minimal processing overhead.

### FIELD OF THE INVENTION

The present invention relates generally to processing systems and more particularly to techniques for providing secure data storage in a processing system memory.

### BACKGROUND OF THE INVENTION

A typical processing system may utilize an external memory for data storage. For example, such a system may be implemented as a system on a chip (SOC) which comprises a processor that accesses both on-chip and off-chip memory. Secure computation can be achieved if the software is secure and the associated instructions and data remain entirely on-chip and are not exposed to external view. But once data is transferred off-chip, it becomes vulnerable to attack and the security of a given computation may be compromised. For example, an adversary could obtain access to an unprotected off-chip memory and examine the stored data, possibly detecting secret information. The adversary could even modify the stored data and thereby subvert an otherwise secure computation.

These security issues are generally addressed by encrypting data prior to its storage in an off-chip memory or other external memory of a processing system. However, encryption alone may provide insufficient protection against a determined adversary. For example, such an adversary could modify the encrypted data, and the modified encrypted data could later be retrieved by the processor, decrypted and accepted as valid.

It is well known that storage of a digital signature can allow detection of this type of tampering with encrypted data. The signature is an example of what is more generally referred to herein as a message authentication code (MAC). A MAC is generated from the encrypted data prior to storage, and upon retrieval of the encrypted data, another, MAC is generated from the retrieved encrypted data and compared with the original MAC. If the encrypted data has been modified while stored in the external memory, the second MAC will not agree with the first, and the processor can determine whether to accept or reject the retrieved encrypted data based on such a determination.

Another security problem that arises in encrypting data for storage in an external memory relates to replay attacks. In a typical replay attack, an adversary with access to the external memory will access or “replay” stored encrypted data in order to attempt to determine the key that was used to encrypt that data. Known techniques for preventing such replay attacks include, for example, incorporating a random value or “nonce” into the data prior to encryption, or using one-time encryption keys. However, such techniques are generally not well suited for use with data stored in an external memory of a processing system. For example, identifying the appropriate nonce for a given read back of encrypted data is problematic. Also, it would be highly inefficient to utilize separate one-time encryption keys for each block of data to be written to an external memory.

Accordingly, a need exists for an improved approach to preventing replay attacks based on encrypted data stored in a memory of a processing system.

### SUMMARY OF THE INVENTION

Illustrative embodiments of the present invention provide secure storage of data in a processing system memory in a manner that is resistant to replay attacks.

In accordance with one aspect of the invention, a key update process applied to encrypted memory in a processing system determines an address from contents of a boundary register, reads an encrypted data block from a memory location specified by the address, decrypts the encrypted data block using a first key, re-encrypts the decrypted data block using a second key, writes the re-encrypted data block back to the memory location specified by the address, and updates the boundary register. These operations are repeated for one or more additional addresses, for example, until data blocks in all memory locations have been re-encrypted using the second key.

In one illustrative embodiment, after the operations have been completed for each of a designated number of memory locations, the first key is updated to a value of the second key, a new second key is generated, and then the operations are repeated again for each of the designated number of memory locations using the updated first key and the new second key. The key update process can be run periodically in this manner, as a background process separate from other read and write transactions to the memory, so as to incur minimal processing overhead. The boundary register contents are also used to determine the appropriate keys for use in these other read and write transactions to the memory.

Another aspect of the invention provides a key update process which utilizes an address permutation approach, in which an address is determined by applying a specified permutation function to the contents of a boundary register. Such an approach advantageously obscures the key update pattern from attackers. In an embodiment without address permutation, the address itself may be stored in the boundary register.

The illustrative embodiments undermine the effectiveness of replay attacks, such as those directed against encrypted data blocks in an external memory of a processing system, while avoiding the above-noted problems associated with incorporation of nonces prior to encryption or use of one-time encryption keys.

### BRIEF DESCRIPTION OF THE DRAWINGS

FIG. 1 shows an illustrative embodiment of a processing system in which the present invention is implemented.

FIG. 2 is a flow diagram of a process for key update to prevent replay attacks in the FIG. 1 system.

FIG. 3 is a diagram illustrating an implementation of the FIG. 2 process in the FIG. 1 system.

FIG. 4 is a diagram illustrating another possible implementation of the FIG. 2 process in the FIG. 1 system, utilizing address permutation.

FIG. 5 shows an alternative version of the FIG. 3 embodiment, utilizing multiple boundary registers.

### DETAILED DESCRIPTION OF THE INVENTION

The invention will be described herein in conjunction with illustrative embodiments of processing systems and associated secure off-chip storage techniques. It should be understood, however, that the invention is not limited to use with the particular processing systems and techniques described, but is instead more generally applicable to any type of processing system application in which it is desirable to provide improved protection against replay attacks on stored encrypted data.

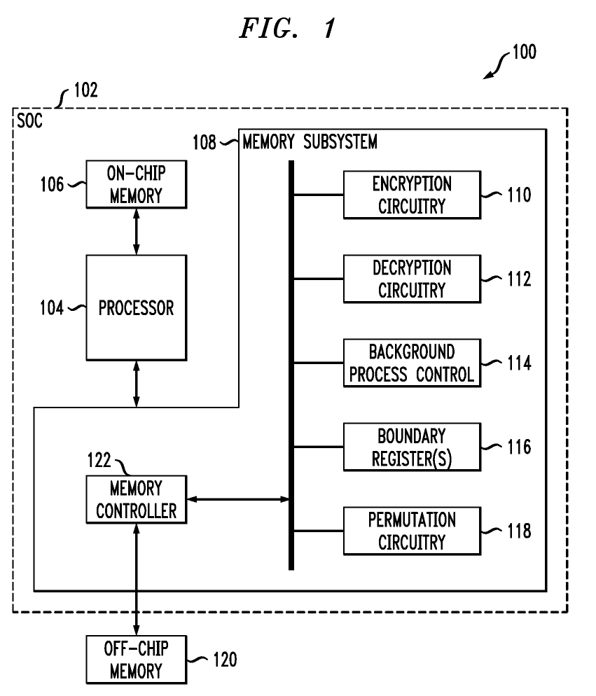

FIG. 1 shows an illustrative embodiment of a processing system 100. The system 100 comprises an SOC 102 that includes a processor 104, an on-chip memory 106 and a memory subsystem 108. The memory subsystem 108 includes encryption circuitry 110, decryption circuitry 112, background process control logic 114, one or more boundary registers 116, and permutation circuitry 118. The processor 104 controls the operation of the memory subsystem 108, and is also configured to store information in and retrieve information from both the on-chip memory 106 and an off-chip memory 120. The processor 104 communicates with the off-chip memory 120 via a corresponding memory controller 122 of the memory subsystem 108. The memory controller 122 operates in conjunction with one or more of the other elements 110-118 of the memory subsystem to modify transactions to off-chip memory. For example, the memory controller interacts with encryption circuitry 110 in encrypting data blocks for storage in the off-chip memory and interacts with decryption circuitry 112 in decrypting encrypted data blocks retrieved from the off-chip memory.

The memory 120 is referred to herein as an “off-chip” memory in that this memory is not part of the chip that implements the SOC 102. Accordingly, it may be implemented using one or more chips that are separate from the SOC. In an arrangement of this type, the SOC itself may be viewed as a zone of trust, with the off-chip memory being outside of this zone of trust. As noted previously herein, in conventional systems, once data is transferred off-chip, such data becomes vulnerable to attack and the security of the overall system may be compromised. Aspects of the present invention address this problem by providing techniques for secure off-chip data storage.

Although the processor 104, on-chip memory 106, and memory subsystem 108 are shown as separate elements in the figure, this is by way of illustrative example only. In other embodiments, at least a portion of the functionality of the memory subsystem may be incorporated into the processor or an alternative SOC element, such as a cryptography engine. For example, such functionality may be implemented at least in part in the form of one or more software programs that are stored in one of the memories 106, 120 and executed by the processor. As another example, the memory controller may be configured to incorporate one or more of the elements 110-118. The memory controller or one or more elements of the memory subsystem 108 may also or alternatively be incorporated into the processor 104. Thus, the particular arrangement of system elements as shown in FIG. 1 should be viewed as exemplary only.

The term “processor” as used herein is intended to be construed broadly so as to encompass, for example, a microprocessor, central processing unit (CPU), digital signal processor (DSP), computer, application-specific integrated circuit (ASIC), or other type of processing device, as well as combinations of such devices. Such a processor may comprise internal memory, registers and other conventional elements.

The memory subsystem 108 is an example of what is more generally referred to herein as “memory circuitry.” Such memory circuitry may comprise one or more of the elements of the subsystem 108, for example, memory controller 122, or combinations of one or more such elements. The term is intended to be construed broadly, and may further or alternatively comprise, for example, at least a portion of one or more system memories such as memories 106, 120.

The processing system 100 may further include other elements not explicitly shown in the figure, but commonly included in conventional implementations of SOCs, computers or other processing systems. For example, the SOC 102 may further comprise an additional memory controller for interfacing the processor 104 with the on-chip memory 106. These and other conventional elements, being well understood by those skilled in the art, will not be described in detail herein.

The system 100 may be configured to store MACs in association with encrypted data blocks. For example, embodiments of the present invention may utilize the in-line MAC storage and retrieval techniques disclosed in U.S. patent application Ser. No. 11/966,101, filed Dec. 28, 2007 and entitled “Storage and Retrieval of Encrypted Data Blocks with In-Line Message Authentication Codes,” the disclosure of which is incorporated by reference herein. However, the use of MACs is not a requirement of the present invention.

The processing system 100 as shown in FIG. 1 is advantageously configured to provide key update via periodic re-encryption of data blocks that are stored in the off-chip memory 120. Generally, one or more of the data blocks are retrieved, decrypted using the key that they were previously encrypted with, and then re-encrypted using a new key, with the re-encrypted block(s) being stored back into the off-chip memory. This periodic updating of the key used to encrypt the data serves to deter replay attacks on the off-chip memory.

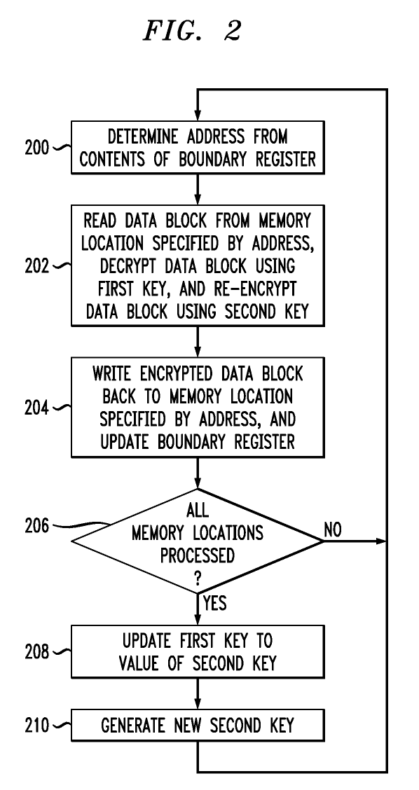

FIG. 2 shows one embodiment of a key update process for providing enhanced security for off-chip data storage in the FIG. 1 system. The process in this embodiment includes steps 200 through 210. The process is initialized with first and second keys. The first key at the initial step of the process is a key that has been used to encrypt one or more encrypted data blocks that are stored in the off-chip memory 120. The second key is a different key that will be used to update the encryption in the manner described below. This second key, and any other keys referred to herein, can be generated in a straightforward manner using any of a variety of techniques well known to those skilled in the art. Although described with reference to symmetric key arrangements in which the same key used to encrypt a given data block is also used to decrypt that data block, the disclosed techniques can be adapted in a straightforward manner for use with other types of key arrangements.

In step 200, an address is determined from the contents of a boundary register 116. For example, the address itself may be contained within the boundary register, or the contents of the boundary register may be processed to generate the address.

In step 202, an encrypted data block is read from a memory location specified by the address obtained in step 200. The encrypted data block is decrypted using a first key, and then re-encrypted using a second key that is different than the first.

In step 204, the re-encrypted data block is written back to the memory location specified by the address, and the boundary register 116 utilized in step 200 is updated.

The key update process will generally start with a particular address as determined from the boundary register contents, and after all of a designated set of memory locations have been processed, the boundary register contents will again indicate that particular address. Thus, regardless of the particular address at which the process starts, it will eventually return to that address after all memory locations have been processed.

A determination is made in step 206 as to whether or not all of the memory locations subject to the key update process have been processed in steps 200 through 204. If all of the memory locations have not been processed, steps 200 through 204 are repeated for one or more additional locations. Otherwise, the process moves to step 208, where the value of the first key is updated to the value of the second key, followed by generation of a new second key in step 210. Thus, the first key is updated by replacing it with the second key, and a new second key is generated. The process then returns to step 200 to begin again with the updated first key and the new second key as determined in respective steps 208 and 210.

The FIG. 2 key update process can be implemented so as to run as a background process that is applied to the off-chip memory 120 in a manner separate from other read and write transactions involving that memory. For example, the key update process can be implemented as part of a periodic refresh operation applied to the memory, or as part of an error correction code (ECC) scrubbing operation applied to the memory. Certain types of memory, such as dynamic random access memory (DRAM), require periodic refresh, and any ECC-protected memory requires periodic scrubbing in which all locations are read and error-corrected values are written back to memory. Thus, the key update process can be incorporated into these otherwise-conventional refresh or scrubbing operations, and need not add any appreciable processing overhead.

The background process control logic 114 of the memory subsystem 108 may be configured to control the performance of the key update process in conjunction with a refresh or scrubbing operation, or as a separate stand-alone background process. The key update process need not, however, be implemented as a background process.

It is to be appreciated that the particular process steps shown in FIG. 2 are not requirements of the invention, and alternative embodiments may utilize other operations to provide key update in the context of secure off-chip data storage.

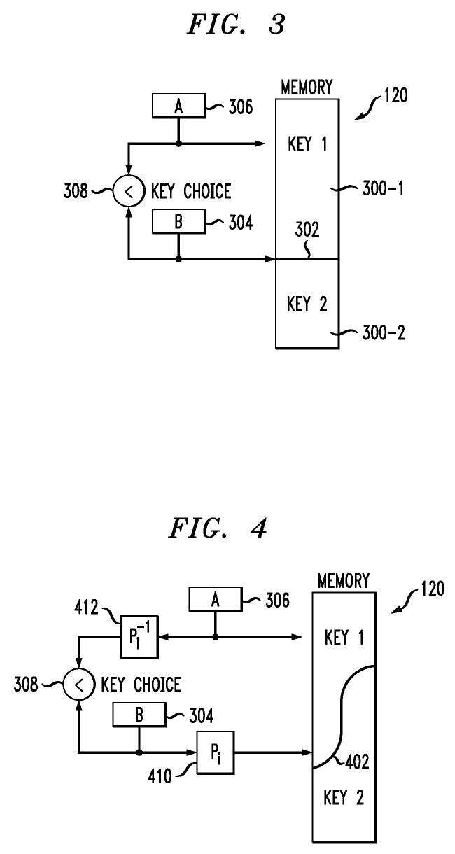

FIG. 3 illustrates one possible implementation of the above-described key update process in the system 100 of FIG. 1. In this diagram as shown, it is assumed that the FIG. 2 key update process is underway in the off-chip memory 120, resulting in a first region 300-1 of the memory in which encrypted data blocks are encrypted under a first key denoted Key 1 and a second region 300-2 of the memory in which encrypted data blocks are encrypted under a second key denoted Key 2. A boundary 302 between the two regions 300-1 and 300-2 indicates the dividing line between those memory locations that have already been re-encrypted using Key 2 and those that remain encrypted under Key 1. A boundary register B, also denoted as element 304, stores the address of the last memory location that has been subject to the key update process. This address is also referred to herein as the boundary address. The boundary register B is part of element 116 in the memory subsystem 108 of FIG. 1.

In performing a write transaction to write a given encrypted data block to the off-chip memory 120 configured as shown in FIG. 3, an address of the memory location to which the block is to be written is stored in an address register A, also denoted as element 306, which may be implemented in the memory controller 122. A comparison element 308, which may also be implemented in the memory controller 122, compares the write address stored in register A with the boundary address stored in boundary register B. If the address of the memory location to which the block is to be written is greater than or equal to the address stored in the boundary register, Key 1 is used to encrypt the data block, and otherwise Key 2 is used to encrypt the data block.

Similarly, in performing a read transaction to retrieve a given encrypted data block from the off-chip memory 120 configured as shown in FIG. 3, an address of the memory location of the data block is stored in address register A. Comparison element 308 compares the read address stored in register A with the boundary address stored in boundary register B. If the address of the memory location from which the block is to be read is greater than or equal to the address stored in the boundary register, Key 1 is used to decrypt the data block upon its retrieval, and otherwise Key 2 is used to decrypt the data block.

The FIG. 2 key update process runs in the background of read and write transactions of the type described above. A given encrypted data block is read from a memory location and decrypted using Key 1 on the Key 1 side of the boundary 302. Then the data block is re-encrypted with Key 2 and written back to its memory location. The boundary address is updated to reflect that this newly written memory location is now in the second encryption region. Subsequent accesses to that location will be decrypted with Key 2. As this background process of converting encrypted memory locations from Key 1 to Key 2 proceeds, eventually all of the memory locations will be encrypted with Key 2. Key 1 is discarded and can no longer be used in a replay attack. At this point, a new key is generated and the process repeats all over again, updating to the new key. In this way, encrypted memory contents will not use the same encryption key for any substantial length of time, thus greatly diminishing the ability of an attacker to perform a replay attack.

In the FIG. 3 embodiment, the key update process follows a monotonically increasing function of the memory location address. Alternative embodiments of the invention may utilize other key update techniques, such as an address permutation approach, an example of which will now be described with reference to FIG. 4. In this example, different portions of off-chip memory 120 are again encrypted using Key 1 and Key 2, but the boundary register contents are altered via a random permutation function prior to referencing memory. The memory location address of a read or write transaction is passed through the inverse permutation function, prior to comparison with the boundary register contents, in order to determine if Key 1 or Key 2 should be used for that memory location. This approach allows the key update process to follow a random address pattern in the off-chip memory as determined by the permutation function. An attacker cannot distinguish this pattern of memory encryption updates from regular memory accesses. The permutation function may be altered each time a new key is generated, so the generated address pattern changes with each update period.

As indicated in FIG. 4, the Key 1 and Key 2 portions of the off-chip memory 120 do not contain contiguous memory locations, due to the address permutation. This obscures the boundary 402 between the portions from attackers.

The FIG. 2 key update process again runs in the background, with a particular address being determined in step 200 by applying a specified permutation function Pi in element 410 to the contents of the boundary register B.

In performing a write transaction to write a given encrypted data block to the off-chip memory 120 configured as shown in FIG. 4, an address of the memory location to which the block is to be written is stored in address register A. That address is subject to inverse permutation function pᵢ⁻¹ in element 412. The comparison element 308 compares the inverse permuted write address with the contents of the boundary address B. If the inverse permuted address of the memory location to which the block is to be written is greater than or equal to the boundary register contents, Key 1 is used to encrypt the data block, and otherwise Key 2 is used to encrypt the data block.

Similarly, in performing a read transaction to retrieve a given encrypted data block from the off-chip memory 120 configured as shown in FIG. 4, an address of the memory location of the data block is stored in address register A. That address is subject to inverse permutation function pᵢ⁻¹ in element 412. Comparison element 308 compares the inverse permuted read address with the contents of the boundary register B. If the inverse permuted address of the memory location from which the block is to be read is greater than or equal to the boundary register contents, Key 1 is used to decrypt the data block upon its retrieval, and otherwise Key 2 is used to decrypt the data block.

The permutation and inverse permutation elements 410 and 412 of FIG. 4 are illustratively implemented in permutation circuitry 118 in the memory subsystem 108 in system 100 of FIG. 1. A wide variety of hash functions and other techniques known in the art may be used as permutation functions in embodiments of the invention.

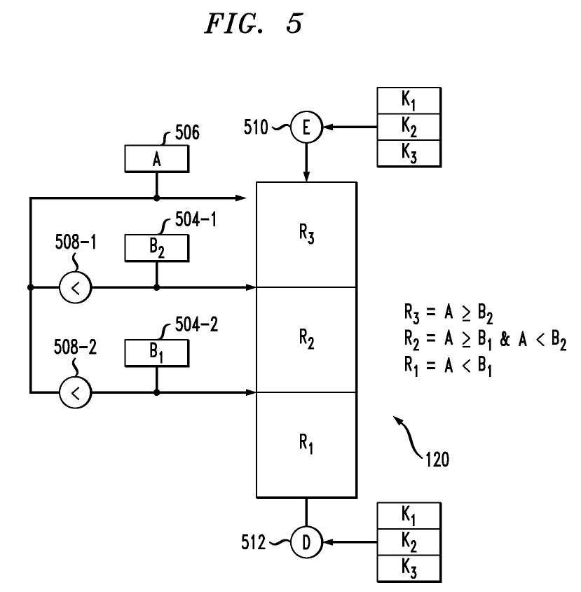

It should be noted that present invention is not limited to arrangements such as those of FIGS. 2 through 4 that utilize a single boundary register. Various arrangements utilizing multiple boundary registers, and thus more than two distinct memory regions, can be configured. FIG. 5 shows one example of an arrangement of this type, in which memory 120 may, at a given point in the key update process, include the three regions denoted R₁, R₂ and R₃. There are two boundary registers B₁ and B₂ in this example, also denoted as elements 504-1 and 504-2, with boundary register B₁ denoting the boundary between regions R₁ and R₂, and boundary register B₂ denoting the boundary between regions R₂ and R₃. Keys K₁, K₂ and K₃ are used by encryption function 510 and decryption function 512 in encrypting and decrypting data in the respective regions R₁, R₂ and R₃. Address register 506 stores a read or write address that is compared in comparison elements 508-1 and 508-2 with respective boundary addresses from the boundary registers 504-1 and 504-2 in order to determine the particular key that should be used to a given read or write transaction to memory 120. More specifically, as indicated in the figure, the read or write address is in region R₃ if the address in register A is greater than or equal to the boundary address in B₂, in region R₂ if the address in register A is greater than or equal to the boundary address in B₁ and less than the boundary address in B₂, or in region R₁ if the address in register A is less than the boundary address in B₁.

Although the FIG. 5 embodiment does not utilize address permutation, such permutation could be incorporated in a straightforward manner using techniques similar to those described above in the context of FIG. 4.

The particular processing arrangements shown in FIGS. 3, 4 and 5 should be viewed as illustrative examples of key update techniques suitable for use in the processing system 100 of FIG. 1. It is to be understood that the invention can be implemented using alternative techniques, implemented using a wide variety of alternative hardware, software and firmware components. For example, it was noted above that at least a portion of the functionality of the memory subsystem 108 could be implemented in the form of one or more software programs executed by the processor 104.

The illustrative embodiments described above advantageously allow key update to occur as a background process in an encrypted off-chip memory. Thus, replay attacks can be discouraged or prevented without incurring a substantial penalty in terms of processing overhead. Although described with reference to an off-chip memory, the techniques can be adapted in a straightforward manner for use with any type of memory in which it is desirable to limit the effectiveness of replay attacks.

It should again be emphasized that the above-described embodiments are intended to be illustrative only. For example, the processing system configuration and key update process can be altered in other embodiments. Also, various system features, such as the number and arrangement of different memory regions, the particular key types used, the boundary register configurations, and the comparison operations, can be altered in other embodiments. These and numerous other alternative embodiments within the scope of the following claims will be readily apparent to those skilled in the art.

We claim:

1. A method comprising the steps of:
(a) determining an address from contents of a boundary register;
(b) reading an encrypted data block from a memory location specified by the address;
(c) decrypting the encrypted data block using a first key;
(d) re-encrypting the decrypted data block using a second key;
(e) writing the re-encrypted data block back to the memory location specified by the address;
(f) updating the boundary register; and
(g) repeating steps (a) through (f) for at least one additional address.

2. The method of claim 1 wherein step (g) further includes, after steps (a) through (f) have been completed for each of a designated number of memory locations, updating the first key to a value of the second key, generating a new second key, and then repeating steps (a) through (f) for each of the designated number of memory locations using the updated first key and the new second key.

3. The method of claim 1 further including the step of determining a key to use in encrypting a given data block to be written to a memory location in a write transaction by comparing an address of the memory location to which the block is to be written with an address stored in the boundary register.

4. The method of claim 3 wherein if the address of the memory location to which the block is to be written is greater than or equal to the address stored in the boundary register, the first key is used to encrypt the data block, and otherwise the second key is used to encrypt the data block.

5. The method of claim 1 further including the step of determining a key to use in decrypting a given data block retrieved from a memory location in a read transaction by comparing an address of the memory location that stores the data block with an address stored in the boundary register.

6. The method of claim 5 wherein if the address of the memory location that stores the given data block is greater than or equal to the address stored in the boundary register, the first key is used to decrypt the data block, and otherwise the second key is used to decrypt the data block.

7. The method of claim 1 wherein step (a) comprises determining the address by applying a specified permutation function to the contents of the boundary register.

8. The method of claim 7 further including the step of determining a key to use in encrypting a given data block to be written to a memory location in a write transaction by comparing a result of applying an inverse of the specified permutation function to an address of the memory location to which the block is to be written with the contents of the boundary register.

9. The method of claim 7 further including the step of determining a key to use in decrypting a given data block retrieved from a memory location in a read transaction by comparing a result of applying an inverse of the specified permutation function to an address of the memory location that stores the data block with the contents of the boundary register.

10. The method of claim 1 wherein steps (a) through (f) are implemented as part of a background process that is applied to a memory and is separate from other read and write transactions involving the memory.

11. The method of claim 10 wherein the background process is implemented as part of a periodic refresh operation applied to the memory.

12. The method of claim 10 wherein the background process is implemented as part of an error correction code scrubbing operation applied to the memory.

13. The method of claim 1 wherein the boundary register is one of a plurality of boundary registers utilized to track boundaries between at least three distinct regions of memory corresponding to respective first, second and third keys.

14. The method of claim 1 wherein the steps are implemented by a system on a chip and the memory locations comprise memory locations in an off-chip memory relative to said system.

15. A machine-readable storage medium having encoded therein machine-executable instructions that when executed implement the steps of the method of claim 1.

16. An apparatus comprising:
a processor; and
memory circuitry coupled to the processor;
wherein the memory circuitry under the control of the processor is operative to determine an address from contents of a boundary register, to read an encrypted data block from a memory location specified by the address, to decrypt the encrypted data block using a first key, to re-encrypt the decrypted data block using a second key, to write the re-encrypted data block back to the memory location specified by the address, to update the boundary register, and to repeat the operations for at least one additional address.

17. The apparatus of claim 16 wherein the memory circuitry comprises a memory subsystem having a memory controller that interfaces the processor to a memory that is external to the processor.

18. The apparatus of claim 16 wherein the memory circuitry comprises permutation circuitry configured to determine an address by applying a specified permutation function to the contents of the boundary register.

19. A processing system comprising:
a processor;
memory circuitry coupled to the processor, the memory circuitry and the processor being implemented as elements of an integrated circuit; and
a memory external to the integrated circuit;
wherein the memory circuitry is configured to interface the processor to the external memory; and
wherein the memory circuitry under the control of the processor is operative to determine an address in the external memory from contents of a boundary register, to read an encrypted data block from a memory location specified by the address, to decrypt the encrypted data block using a first key, to re-encrypt the decrypted data block using a second key, to write the re-encrypted data block back to the memory location specified by the address, to update the boundary register, and to repeat the operations for at least one additional address in the external memory.

20. The system of claim 19 wherein the memory circuitry comprises a memory subsystem having a memory controller that interfaces the processor to the external memory.
